(19) United States
(12) Patent Application Publication
(10) Pub. No.: US 2008/0230595 A1
(43) Pub. Date: Sep. 25, 2008

(54) Automated audio, video, and data extraction

(76) Inventors: Yugal K. Sharma, Washington, DC (US); Tad Richman, Washington, DC (US)

Correspondence Address: Nields & Lemack, 176 E. Main Street, Suite #5, Westboro, MA, 01581, US

(21) Appl. No.: 12/075,846

(22) Filed: Mar. 14, 2008

Related U.S. Application Data
(60) Provisional application No. 60/918,549, filed on Mar. 16, 2007.

(51) Int. Cl. G06F 19/00

(52) U.S. Cl. 235/375

(57) ABSTRACT

A system and method for loading, processing and classifying media used in an automated system is disclosed. A robotic arm, or similar device, is used to pick a piece of media from a set of unprocessed discs in a first location and place that medium into a suitable media reader, such as a CDROM reader or DVD reader. A computing system, in communication with the media reader, determines whether the media was properly processed. If so, it is placed in a second location. If it is not properly processed, the robotic arm places the media in a third location, where it can be manually inspected and analyzed at a later time. In another embodiment, the computing system discriminates between various reasons for the inability to process the media and places the offending media in a location designated specifically for that failure type. At a convenient time, manual inspection and intervention can be used to correct the failed media. The system can also be used to sort media based on other criteria, such as media type, defect rate, or type of content. In all cases, the computing system also optionally generates an import log that tracks all discrepancies.

This application claims priority of U.S. Provisional application Ser. No. 60/918,549 filed Mar. 16, 2007, the disclosure of which is incorporated herein by reference.

### BACKGROUND OF THE INVENTION

As technology moves forward, it leaves behind a wake of information in a variety of formats that may not be desired for future applications. For example, consider entertainment media. For audio material, there has been a plethora of formats, such as vinyl recordings, which existed at 33, 45 and 78 cassette recordings, and 8-Track recordings. All of these formats are nearly extinct today, replaced by digital media, such as compact disks (CDs). To date, there are almost 16 billion CDs in circulation in the United States, with over 600,000,000 new CDs added to this number each year. CDs represented 97% of all music sales in 2005, and the vast majority of music will probably remain on physical CDs for many years to come. At the same time, portable digital players, digital media centers, and digital music servers continue to proliferate at an exponential rate, while radio stations, online music stores, and internet-based music require this growing archive of music CDs to be digitized to a variety of CODECs and formats. The same holds true for video, as DVDs are the main physical repository of movies, yet a new generation of media centers and digital video devices require non-physical, digital versions of this legacy archive. Thus, while technology continues to move forward, it is also diverging. Previously, the single standard used by CDs and DVDs served the needs of nearly every user. Today, users demand digital media in a variety in different, and often incompatible formats, for use with MP3 players, iPODs®, personal computers, DVD players, media centers, etc.

Presently, practitioners in the field use a multistage approach to converting legacy data:

Stage 1: Extraction
Extraction of raw data from original media into computable format
Error correction/enhancement of raw data

Stage 2: Conversion
Conversion of corrected raw data
Data categorization (metadata, keywords, etc)
Digital Rights Management

Stage 3: Storage of final product

The second stage of this process is widely regarded as the most computational intensive. However, the first stage, extraction, has the potential to be the one requiring the most manual intervention. For example, the extraction may require the manual loading of tens, hundreds or even thousands of CDs and DVDs. While there are carousal devices that accept many CDs at a time, these still must be loaded. The amount of manpower required to perform this function can be costly. Therefore, a more automated process is required.

The use of robotics to load the CDs can potentially be viewed as a solution to this dilemma. However, the extraction process is not trivial. For example, the media may contain errors that make it impossible to process them. Without manual intervention, there is no way to easily determine which media were processed correctly and which weren't. Additionally, there are numerous reasons why media may fail to be processed correctly. Each of these causes may require different remedial action. Without knowing which piece of media failed and why it failed, a robotics system may not be the panacea that it seems to be.

Therefore, a system that addresses these shortcomings would be advantageous, especially since the presentation of media and the extraction of the data from them can be a significant contributor to cost in an automated system if manual intervention is required.

### SUMMARY OF THE INVENTION

The shortcomings of the prior art have been addressed by the present invention, which describes a system and method for loading, processing and classifying media used in an automated system. A robotic arm, or similar device, is used to pick a piece of media from a set of unprocessed media in a first location and place that piece of media into a suitable media reader, such as a CDROM reader or DVD reader. A computing system, in communication with the media reader, determines whether the piece of media was properly processed. If so, it is placed in a second location. If it is not properly processed, the robotic arm places the piece of media in a third location, where it can be manually inspected and analyzed at a later time. In another embodiment, the computing system discriminates between various reasons for the inability to process the piece of media and places the offending piece of media in a location designated specifically for that failure type. In all cases, the computing system also optionally generates an import log that tracks all discrepancies. At a convenient time, manual inspection and intervention can be used to correct the failed pieces of media.

### BRIEF DESCRIPTION OF THE FIGURES

FIG. 1(a) illustrates a front view of a representative embodiment of the present invention; and

FIG. 1(b) illustrates a top view of a representative embodiment of the present invention.

### DETAILED DESCRIPTION OF THE INVENTION

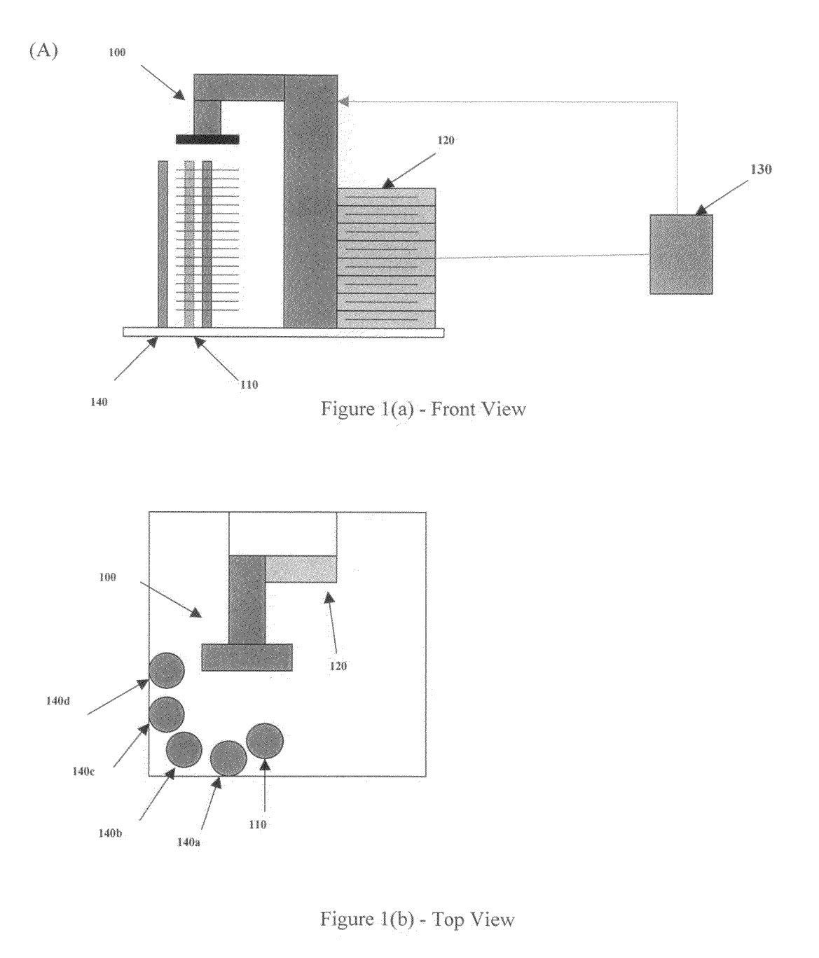

FIG. 1(a) illustrates a front view of the present invention. A robotic arm 100, or similar automated mechanical device, is used to select and carry a piece of media from an input spindle 110 to a suitable media reading device, such as a CDROM reader 120. The input spindle 110 contains the unprocessed media. If desired, a number of media reading devices 120 can be used in improve the throughput of the computing system. In FIG. 1(a), 8 media reading devices are shown, although any number of devices can be used and are within the scope of the invention. The reading devices 120 are in communication with a computing system 130. The computing system 130 is also in communication with the robotic arm 100, so as to control its actions. At least one output spindle 140 is provided onto which previously processed media are placed. Preferably, more than one additional spindle 140a, 140b, 140c, 140d is provided so as to allow processed media to be categorized and separated based on the processing results, as will be explained in more detail below. Although spindles 140 are the preferred method of holding and stacking the media, the invention is not so limited. Any device capable of holding a collection of media can be utilized.

The above described system can be used in a variety of ways. For example, a plurality of output spindles can be employed, as shown in FIG. 1(b).

In one embodiment, the system is used to read a set of CDs and convert their contents into a second digital format. In this embodiment, only original audio CDs are processed, while DVDs, data CDs and CD-Rs (CDs which have been burned by a consumer) are rejected. To begin, the computing system 130 commands the robotic arm 100 to pick one of the discs from the unprocessed spindle 110. The arm 100 optionally performs a controlled shake to protect against picking up multiple discs, places the disc into one of the media readers 120. The computing system 130 then uses software to query the disc in the drive. In one embodiment, Operating System-level tools are used to query the disc in the media reader 120. In the preferred embodiment, when a disc is inserted and the media reader 120 is closed, the Linux OS tool ‘cdctl’ attempts to read the information on the disc and determine its status. In another embodiment, standard or customized CDROM device drivers can be used to query the disc.

If no disc is detected by the computing system 130, the computing system 130 will attempt to re-read the disc by automatically opening and closing the tray of the media reader. If subsequent attempts to read the disc also fail, the software in the computing system 130 accesses the robotic firmware, and the robotic arm 100 is instructed to remove the disc and place it into one of the output spindles 140c. In one embodiment, output spindle 140c is used to hold discs that have been rejected. This rejection may be as a result of being the wrong type of media (DVD, data CD, CD-R, etc), or because the disc is completely unreadable.

If the software, such as ‘cdctl’, detects a data CD or DVD in the media reader, the rejected disc is automatically placed in the output spindle 140c, which, as described above, holds rejected discs. In practice, this spindle 140c holds discs which will not be re-processed by the system.

If the computing system 130 detects that an audio CD is in the media reader 120, a second software routine is used to determine whether the audio CD is a CD-R. In the preferred embodiment, a separate Linux OS tool, ‘cdrecord’ is used. If the audio CD is a CD-R, the computing system 130 rejects the disc and it is and placed into output spindle 140c. While the preferred embodiment rejects CD-Rs due to potential copyright violations, this is not a requirement of the system. Each of the above instances are preferably logged and reported back to the customer for traceability.

If the disc passes both of the checks described above, the software then reads the “Table-of-Content” (TOC) information from the audio CD disc and uses this to query a third-party database (or a local database) containing metadata information for the disc. Several third-party database services, such as but not limited to Gracenote, freedb.org and AMG, can be used to obtain relevant metadata information. Alternatively, or additionally, a local database containing this metadata can be accessed. The metadata returned by the database includes, but is not limited to the artist's name, album name, track names, year, and genre. This information is preferably saved to a local text file which is later associated with the extracted data on a track-level. The computer system can optionally also run a metadata modification script at this point that standardizes metadata pulled from external or internal databases. Modification can be but is not limited to multiple disc album and box set classification, rules for compilation and greatest Hit albums, and genre specific albums such as classical.

If there is no associated metadata in the database, the robotic arm is directed to place the unknown disc into one of the output spindles 140d. This spindle is used for those CDs that require additional manual processing. For example, these CDs can be retrieved later for manual processing and incorporation of metadata from other, non-database sources. For example, the jewel case, if available, will typically have the required information. Alternatively, the information may be available through an internet search.

After successful metadata retrieval, the audio extraction process begins. During the extraction process, blocks of data are extracted. In the preferred embodiment, the block size is user defined, however it can also be a fixed size or determined using another method or algorithm. In the preferred embodiment, the blocks of data are extracted multiple times, where the number of extractions is also user defined, and compared. While the preferred embodiment extracts the blocks of data multiple times to insure data integrity, this is not a requirement. The data can be extracted a single time if desired. In the preferred embodiment, the multiple copies of the extracted blocks are then compared bit-by-bit. If the comparison is successful, the data is saved and the next block is extracted in similar fashion. If the comparison fails, the data blocks are rejected and that block is re-read from the disc as described. The comparison and re-reading process continues until the block is extracted successfully, or a first threshold is reached. This threshold can be a fixed value, or determined by any other method. In one embodiment, a value of 10 is used. If this first threshold is reached, the track is logged as a failed extraction. If the number of tracks on a given audio CD that failed block extractions exceeds a second threshold, the disc is placed onto output spindle 140b. This second threshold, like the first threshold value, can be a fixed value, or determined by any other method. Output spindle 140b is reserved for those discs which are definitely audio CDs, but cannot be reliably read. If the disc is simply dirty, an operator can manually clean the CD and reprocess it by moving it back onto input spindle 110. In the case of physically damaged discs, these can be flagged as defective and reported to alert the customer.

In the DVD extraction embodiment, the system is used to read a set of DVDs, most of which are protected by the Content Scramble System (“CSS”), a method used to encrypt the video and audio data. In certain cases, successful extraction entails maintaining the CSS protection as part of a bit-for-bit rip while accounting for the CSS encryption keys found on the disc. Protocols for further protecting and encrypting these keys is then applied by the computing system as the data is imported directly to the media server.

In both scenarios, discs that are properly processed are removed and placed on output spindle 140a. Thus, an entire collection of CDs or DVDs can be processed automatically. In this example, at the completion of the extraction process, there are discs on four possible output spindles. Output spindle 140a is reserved for successfully processed discs, with the option to maintain the original order of the discs. Output spindle 140b is reserved for disc of questionable reliability that experience excessive read errors. Output spindle 140c is reserved for those discs that are rejected. Lastly, output spindle 140d is reserved for discs that were properly read, but could not be identified.

Thus, not only is the data extracted, but the discs are also sorted into defined categories. The rejected discs on output spindle 140c are simply given back to the customer. The discs on output spindle 140b are manually cleaned and reprocessed. Optionally, discs from output spindle 140b, which experienced excessive read errors can be automatically retried in a different media reader 120. The use of a different media reader may result in more reliable extraction. If the disc is successfully read by the different media reader 120, it is placed on the output. spindle 140a, reserved for successfully processed discs. The discs on output spindle 140d are manually inspected to determine the appropriate metadata which should be attached to them.

While this embodiment describes four possible classifications of discs, the invention is not so limited. For example, more or fewer classifications can be defined.

In another embodiment, the invention can be used to sort discs into different categories. For example, a set of unknown discs can be sorted into based on type, such as DVD, CD-R, data CD, and audio CD.

In another embodiment, the invention is used to sort discs based on the content thereon. For example, the CD collection can be separated into different spindles based on artist, genre, or any other criteria to which the computing system has access. For DVDs, the invention is used to sort discs based on DVD regional numbers, which effects playback based on the geographical region in which the disc was manufactured.

In another embodiment, the invention is used to sort discs based on the quality of the extraction. For example, discs from which all tracks are successfully extracted are placed onto one output spindle. Those with a single faulty track are placed onto a second output spindle. Those with two defective tracks are placed onto a third output spindle, and so on.

Additionally, the invention is not limited to disc processing. The same theory of operation and enumerated steps can be used for any media type. For example, a set of USB storage devices, ipods®, MP3 players, MultiMedia Cards, FLASH devices, DVDs, or other media types could serve as the input media type. In those cases, the media reader is simply adapted to read the required media type. Thus, instead of utilizing a CD drive as described above, the invention would utilize the appropriate device, such as a USB port in the case of a USB storage device.

The present invention can also be used with a system for converting legacy media types. Such a system is described in co-pending application “High Throughput System for Legacy Media Conversion”, the disclosure of which is hereby incorporated by reference. The combined extraction and conversion phases can be applied into a single system.

What is claimed is:

1. A system for automatically importing and sorting physical media into a plurality of categories, comprising:
a. A receptacle adapted to hold said media, comprising a first input position, where said physical media are placed prior to said sorting operation;
b. A second receptacle comprising a plurality of output positions, each representing one of said plurality of categories, where said media are placed subsequent to said sorting operation;
c. A media reader, adapted to electronic read said physical media;
d. A computing system, in communication with said media reader, wherein said computer system determines which of said plurality of categories the physical medium located in said media reader belongs, and
e. A robotic arm, in communication with said computing system, adapted to pick up said physical medium from said input position, place said medium into said media reader and subsequently place said medium into one of said plurality of output positions.

2. The system of claim 1, wherein said physical media comprises compact discs or digital video discs.

3. The system of claim 2, wherein said media reader comprises a CDROM reader or DVD reader.

4. The system of claim 3, wherein one of said plurality of categories comprises discs which cannot be read by said CDROM reader or DVD reader.

5. The system of claim 3, wherein one of said plurality of categories comprises discs which have data errors.

6. The system of claim 3, wherein said computing system is in communication with at least one database, adapted to provide metadata associated with said media.

7. The system of claim 6, wherein said computing system modifies metadata associated with said media based on defined standards.

8. The system of claim 6, wherein one of said plurality of categories comprises discs for which said database contains no metadata.

9. The system of claim 6, wherein said metadata comprises the genre of said media and one of said plurality of categories comprises discs having a common genre.

10. A method of sorting physical media into a plurality of categories, comprising:
a. Providing a receptacle adapted to hold said media, comprising a first input position, where said physical media are placed prior to said sorting operation, a second receptacle comprising a plurality of output positions, each representing one of said plurality of categories, where said media are placed subsequent to said sorting operation, a media reader, adapted to electronic read said physical media, a computing system, in communication with said media reader, wherein said computer system determines which of said plurality of categories the physical medium located in said media reader belongs, and a robotic arm, in communication with said computing system, adapted to pick up said physical medium from said input position, place said medium into said media reader and subsequently place said medium into one of said plurality of output positions;
b. Picking a physical medium from said input position using said robotic arm;
c. Loading said medium into said media reader;
d. Activating said media reader to read said media wherein data from said media is transferred to said computing system;
e. Selecting an output position for said medium based on said transferred data; and
f. Using said robotic arm to remove said medium from said media reader and place in said selected output position.

11. The method of claim 10, further comprising activating said media reader to identify at least one characteristic of said medium after said medium is loading into said media reader; and selecting an output position for said medium based on said characteristic.

12. The method of claim 10, wherein said computing system selects said output position based on the number of errors in said transferred data.

13. The method of claim 10, further comprising using said transferred data to locate metadata in a database associated with said medium and selecting an output position for said medium based on said metadata.
